(19) United States
(12) Patent Application Publication
(10) Pub. No.: US 2006/0129759 A1
(43) Pub. Date: Jun. 15, 2006

(54) Method and system for error strategy in a storage system

(75) Inventors: Eric John Bartlett, Salisbury (GB); Nicholas Michael O'Rourke, Hampshire (GB); William James Scales, Hampshire (GB)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 11/244,533

(22) Filed: Oct. 5, 2005

(30) Foreign Application Priority Data
Nov. 30, 2004 (GB) 0426309.1

(51) Int. Cl. G06F 12/14

(52) U.S. Cl. 711/114

(57) ABSTRACT

Apparatus and computer program product for enabling an error strategy in a storage system with an initiator and a plurality of storage devices connected by a network, such as a storage area network (SAN). The computer program product is operable for recording timing statistics for transactions between an initiator and a target storage device; analyzing the recorded timing statistics for a target storage device; and applying the statistical analysis for a target storage device to error recovery procedures for the target storage device. The computer program product may also record statistics for transactions between an initiator and a target storage device using a particular network route. The recorded and analyzed timing statistics can be used to provide a dynamic error strategy based on the performance of individual target devices and routes.

### FIELD OF THE INVENTION

This invention relates to the field of error strategy in a storage system. In particular, the invention relates to the field of providing a dynamic time-out strategy using statistical analysis in a storage system.

### BACKGROUND

Existing storage systems typically operate with small storage area networks (SANs) that provide connectivity between a specific storage device and specific host device drivers that know the capabilities of this storage device. In these environments, performance factors such as high latency and load conditions can be tuned by the manufacturer before a product is installed for customer use.

Storage virtualization has developed which enables simplified storage management of different types of storage on one or more large SANs by presenting a single logical view of the storage to host systems. An abstraction layer separates the physical storage devices from the logical representation and maintains a correlation between the logical view and the physical location of the storage.

Storage virtualization can be implemented as host-based, storage-based or network based. In host-based virtualization, the abstraction layer resides in the host through storage management software such as a logical volume manager. In storage-based virtualization, the abstraction layer resides in the storage subsystem. In network-based virtualization, the abstraction layer resides in the network between the servers and the storage subsystems via a storage virtualization server that sits in the network. When the server is in the data path between the hosts and the storage subsystem, it is in-band virtualization. The metadata and storage data are on the same path. The server is independent of the hosts with full access to the storage subsystems. It can create and allocate virtual volumes as required and presents virtual volumes to the host. When an I/O request is received, it performs the physical translation and redirects the I/O request accordingly. For example, the TotalStorage SAN Volume Controller of IBM (trade marks of International Business Machines Corporation) is an in-band virtualization server. If the server is not in the data path, it is out-of-band virtualization.

With the advent of Storage Virtualization Controller (SVC) systems that are connected between the host computer and the storage devices the knowledge of the capabilities of the storage devices is not available. SVCs would typically use many different types of storage on large SANs. The virtualization system may not have been specifically tuned to work with the specific storage device; therefore, some learning is required by the virtualization system to sensibly and reliably operate with the various storage devices.

A typical SCSI storage target device driver would implement a rigid time-out strategy specifying how long it will allow a transaction to take before error recovery procedures begins. In a SAN environment this rigid timing can give rise to unnecessary or late error recovery when the storage target device is working within its normal operating parameters, as latency may be a characteristic of the SAN and other components within it.

Another problem is that different types of storage device have different characteristics and may be used by a single initiator or by a group of initiators. Virtualization products designed to operate using standard SCSI and Fibre Channel interfaces may not know the characteristics of the storage device(s) attached and may not know the characteristics of the SAN that connects them. Indeed, they may also not know how much load is being applied to the SAN or to the storage controller by other hosts and storage controllers, since a single storage controller may be attached to many different hosts and/or SVCs at the same time.

During operation, SANs lose frames that make up a transaction and this causes transactions to time-out. This is a characteristic of any transport system and early and correct detection of problems is important to provide a reliable service to the applications, and ultimately the people, using the SAN.

The SAN fabric latency and reliability will vary independently of the storage devices' latency and reliability. SAN problem diagnosis can be difficult so being able to tell the difference between a storage device problem and a SAN fabric problem is helpful.

Latency problems that are caused by the SAN and/or the storage devices become part of the system's characteristics. Even if a host or SVC “knows” the type of storage device it is attached to and knows that generally that type of controller is fast and reliable, the specifics of the way in which it is being used and is attached cannot possibly be known in advance for every configuration.

Error recovery of the fabric of a SAN can take a significant amount of time, in the order of 20-120 seconds, as transactions may need to be aborted and retried. SAN time-outs may be applied to the abort.

### SUMMARY

An aim of the invention is to improve the abilities of initiator device drivers in both host systems and SVCs.

In a first non-limiting aspect thereof the invention provides a computer program product comprising a computer readable medium including a computer readable program, where the computer readable program when executed on a computer causes the computer to: record timing statistics for transactions between an initiator and a target storage device; analyze the recorded timing statistics for the target storage device and apply a statistical analysis for the target storage device to at least one error recovery procedure for the target storage device.

In a second non-limiting aspect thereof the invention provides an initiator device for coupling to a plurality of storage devices through a network. The initiator device comprises means for recording timing statistics for transactions between the initiator and a target storage device; means for analyzing the recorded timing statistics for the target storage device; and means for applying a statistical analysis for the target storage device to at least one error recovery procedure for the target storage device.

In a further non-limiting aspect thereof the invention provides a computer that comprises a data processor coupled to a memory and an input/output interface for coupling to a plurality of data storage devices through a network. The data processor operates in accordance with computer program instructions stored in the memory to record information, during at least one predetermined time interval, for transactions conducted through the interface via a selected connection through the network with at least one data storage device; to statistically analyze the recorded information; and to apply a result of the statistical analysis to at least one data storage device error recovery procedure.

### BRIEF DESCRIPTION OF THE DRAWINGS

Embodiments of the present invention will now be described, by way of examples only, with reference to the accompanying drawings in which:

FIG. 1 is a block diagram of a general computer storage system in accordance with the present invention;

FIG. 2 is a block diagram of a SAN storage system in accordance with a first embodiment of the present invention;

FIG. 3 is a block diagram of a SVC storage system in accordance with a second embodiment of the present invention;

FIG. 4 is a flow diagram of a process in accordance with the present invention; and

FIG. 5 is a flow diagram of an example error recovery procedure in accordance with the present invention.

### DETAILED DESCRIPTION

A method and system for error strategy is provided in which statistics regarding the processing time between an initiator device and a target storage device are maintained. Error strategies can then be dynamically tailored for specific target storage devices.

The invention is described in the context of two exemplary embodiments. The first embodiment is a SAN system in which a host device is the initiator of storage transactions and is connected to a target storage device via a SAN. The second embodiment is described in the context of a SVC system in which a virtualization controller is provided between the host device and a target storage device. The virtualization controller is the initiator of the transactions to a target storage device.

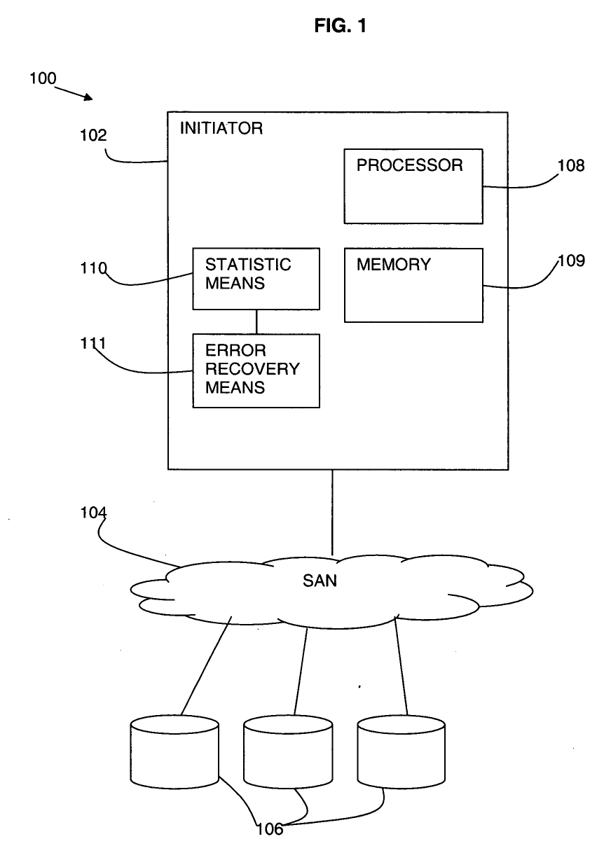

Referring to FIG. 1, a general configuration of a storage system 100 is shown with an initiator device driver 102. In the context of the two embodiments, the initiator device driver 102 may be provided in a host device such as a server or in a virtualization controller. The initiator device driver 102 communicates via a communication means 104, for example, a SAN, with a plurality of storage devices 106. More than one initiator device driver 102 may be connected to the communication means 104 in order to carry out transactions with the same or a different combination of the storage devices 106. The arrangement shown in FIG. 1 is for illustrative purposes, due to the nature of SAN and SVC systems the number of possible configurations of host and storage devices is large.

The initiator device driver 102 includes a processor means 108 and a memory means 109. It also includes means 110 for gathering, processing and storing statistics regarding the processing of transactions by target storage devices 106 and means 111 for applying the statistics to error processes such as time-outs.

The first embodiment is described in the context of storage area networks (SAN). A SAN is a network whose primary purpose is the transfer of data between computer systems and storage elements. In a SAN, storage devices are centralized and interconnected. A SAN is a high-speed network that allows the establishment of direct communications between storage devices and host computers within the distance supported by the communication infrastructure. A SAN can be shared between servers and/or dedicated to one server. It can be local, or can be extended over geographical distances.

SANs enable storage to be externalized from the servers and centralized elsewhere. This allows data to be shared among multiple servers. Data sharing enables access of common data for processing by multiple computer platforms or servers.

The host server infrastructure of a SAN can include a mixture of server platforms. The storage infrastructure includes storage devices which are attached directly to the SAN network. SANs can interconnect storage interfaces together into many network configurations.

The Fibre Channel (FC) interface is a serial interface which is the primary interface architecture for most SANs. However, other interfaces can also be used, for example the Ethernet interface can be used for an Ethernet-based network. SANs are generally implemented using Small Computer Systems Interface (SCSI) protocol running over a FC physical layer. However, other protocols may be used, for example, TCP/IP protocols are used in an Ethernet-based network.

A Fibre Channel SAN uses a fabric to connect devices. A fabric is the term used to describe the infrastructure connecting servers and storage devices using interconnect entities such as switches, directors, hubs and gateways. The different types of interconnect entities allow networks of varying scale to be built. Fibre Channel based networks support three types of topologies, which are point-to-point, arbitrated loop, and switched. These can be stand alone or interconnected to form a fabric.

Within each storage device there may be hundreds of storage volumes or logical units (LU). A route between an initiator device and a target storage device is referred to as a target/initiator context. A logical unit number (LUN) is a local address that a specific LU is accessible through for a target/initiator context. For some controller subsystem configurations, a single LU can be addressed using different LUNs through different target/initiator contexts. This is referred to as LU virtualization or LU mapping.

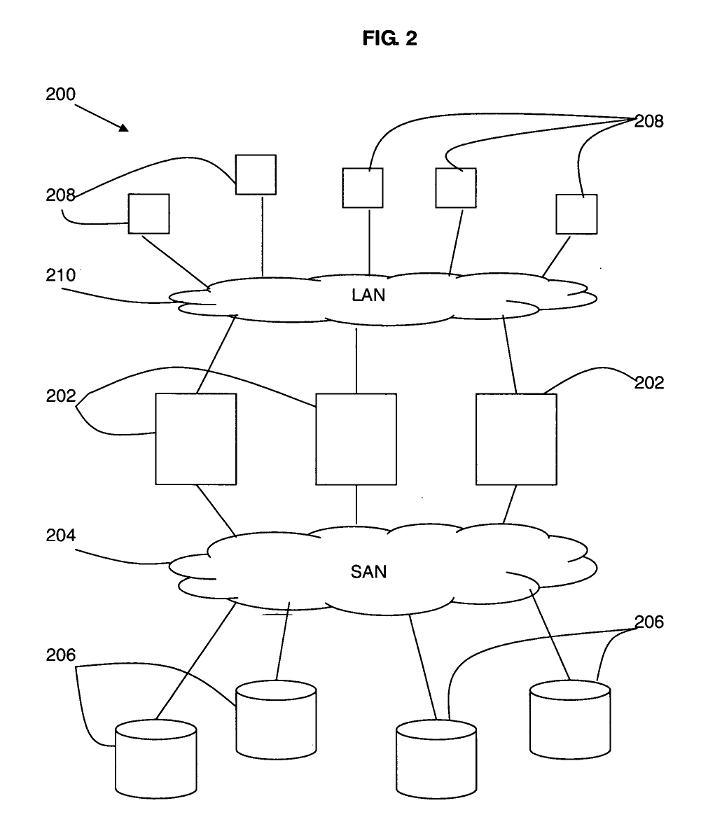

Referring to FIG. 2, a computer system 200 is shown including a storage area network (SAN) 204 connecting multiple servers or host computers 202 to multiple storage systems 206. Multiple client computers 208 can be connected to the host computers 202 via a computer network 210.

Distributed client/server computing is carried out with communication between clients 208 and host computers 202 via a computer network 210. The computer network 210 can be in the form of a Local Area Network (LAN), a Wide Area Network (WAN) and can be, for example, via the Internet.

In this way, clients 208 and host computers 202 can be geographically distributed. The host computers 202 connected to a SAN 204 can include a mixture of server platforms.

The storage systems 206 include storage controllers to manage the storage devices within the systems. The storage systems 206 can include various different forms such as shared storage arrays, tape libraries, disk storage all referred to generally as storage devices. Within each storage device there may be hundreds of storage volumes or logical units (LU). Each partition in the storage device can be addressed by a logical unit number (LUN). One logical unit can have different LUNs for different initiator/target contexts. A logical unit is this context is a storage entity which is addressable and which accepts commands.

A host computer 202 is an initiator device which includes an initiator device driver, which may also be referred to as a host device driver, for initiating a storage procedure such as a read or write request to a target storage device. A host computer 202 may include the functionality of the initiator device driver shown in FIG. 1 for collecting, processing and applying statistics regarding storage procedures to target storage devices.

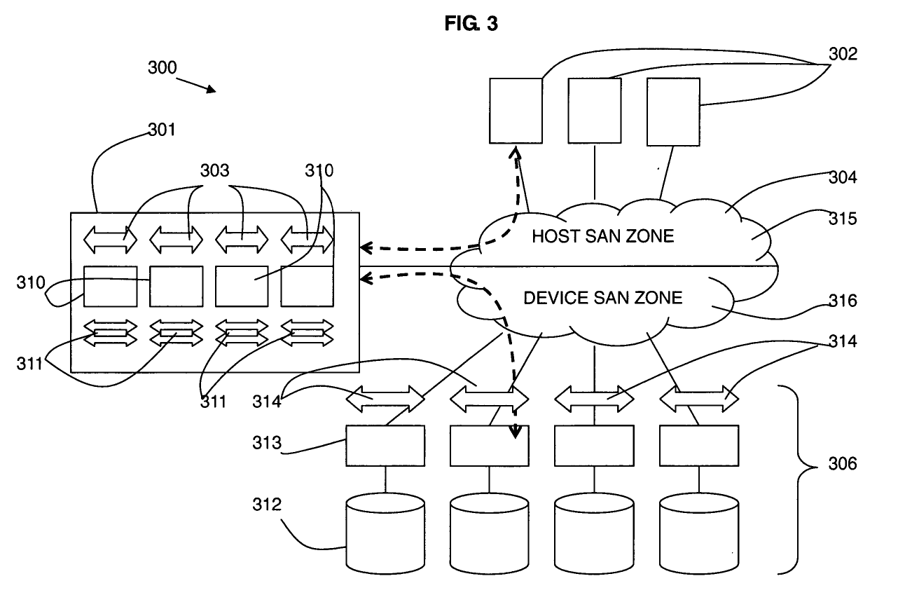

The second embodiment is described in the context of storage virtualization controller (SVC) systems. Referring to FIG. 3, a computer system 300 is shown including a storage virtualization controller 301.

Storage virtualization has been developed to increase the flexibility of storage infrastructures by enabling changes to the physical storage with minimal or no disruption to applications using the storage. A virtualization controller centrally manages multiple storage systems to enhance productivity and combine the capacity from multiple disk storage systems into a single storage pool. Advanced copy services across storage systems can also be applied to help simplify operations.

A network-based virtualization system is shown in FIG. 3 in which a virtualization controller 301 resides between the hosts 302, which are usually servers with distributed clients, and the storage systems 306.

A storage system 306 has a managed storage pool of logical units (LU) 312 with storage controllers 313 (for example, RAID controllers). The addresses (LUNs) 314 of the logical units (LU) 312 are presented to the virtualization controller 301.

The virtualization controller 301 is formed of 2 or more nodes 310 arranged in a cluster which present virtual managed disks (Mdisks) 311 as virtual disks (Vdisks) with addresses (LUNs) 303 to the hosts 302.

A SAN fabric 304 is zoned with a host SAN zone 315 and a device SAN zone 316. This allows the virtualization controller 301 to see the LUNs of the managed disks 314 presented by the storage controllers 313. The hosts 302 cannot see the LUNs of the managed disks 314 but can see the virtual disks 303 presented by the virtualization controller 301.

A virtualization controller 301 manages a number of storage systems 306 and maps the physical storage within the storage systems 306 to logical disk images that can be seen by the hosts 302 in the form of servers and workstations in the SAN 304. The hosts 302 have no knowledge of the underlying physical hardware of the storage systems 306.

A virtualization controller 301 is an initiator device which includes an initiator device driver for transactions with the storage systems 306. A virtualization controller 301 may include the functionality of the initiator device driver shown in FIG. 1 for collecting, processing and applying statistics regarding storage procedures to target storage devices.

The initiator device, whether a host or a virtualization controller, is provided with means for providing error recovery based on statistical analysis of target storage devices. Error recovery procedures can be dynamically adapted according to the statistics for a particular storage device.

Data design would need to be such that appropriate statistics could be recorded against an appropriate context. At a basic level, the statistics data design may include response time statistics recorded against logical unit contexts or targets.

Statistics may be collected by the following method:
1. Send Transaction—recording the time at which it was sent.
2. Transaction completes—calculate the time it took to complete and record this in the statistics data for that connection and storage device object.

This would occur for every transaction. Meanwhile, a timer would be running and calculating the current time-out value for the next transactions, this calculation might be, for example:

Next timeout = Average_xfer time+Peak_xfer_time
If ( Next_timeout < Min_timeout
Next_timeout = Min_timeout )

To allow the time-out to be reduced as well as increased, it is required that the statistics are recorded for a given time period. Several time periods could be used. For example, collecting statistics for every 5 second period may be appropriate, as follows:

| Time period (seconds) | Average Response time | Peak response time |
|---|---|---|
| 0-5 | 5 ms | 10 ms |
| 5-10 | 6 ms | 1000 ms |
| 10-15 | 2000 ms | 5000 ms |
| 15-20 | 10 ms | 100 ms |
| 20-25 | 4 ms | 10 ms |

This shows that the for period between 10 and 15 seconds the performance was clearly “out of character” and the 5 second peaks and 2 second average are well outside the norm.

The minimum statistics recorded for a reasonable implementation might be average and peak times. Other statistics such as the difference between read and writes and longer data transfers may also be useful.

Recording these statistics against a specific initiator-to-target connection allows the system to make better choices for which connection to use next for a transaction.

Every time a transaction is sent, recording this data would allow the average processing time to be calculated. Subsequent transactions can be timed-out when they take longer than expected. For example, a transaction taking 5 times the average if larger than the peak, might be a good algorithm.

Second attempt statistics could also be gathered as this would give an indication of the time the storage controller is taking to do its error recovery and would allow some distinction between the errors introduced by the fabric and the ones introduced by the storage device.

Weighting different types of failure relative to their impact and recovery time may also be useful.

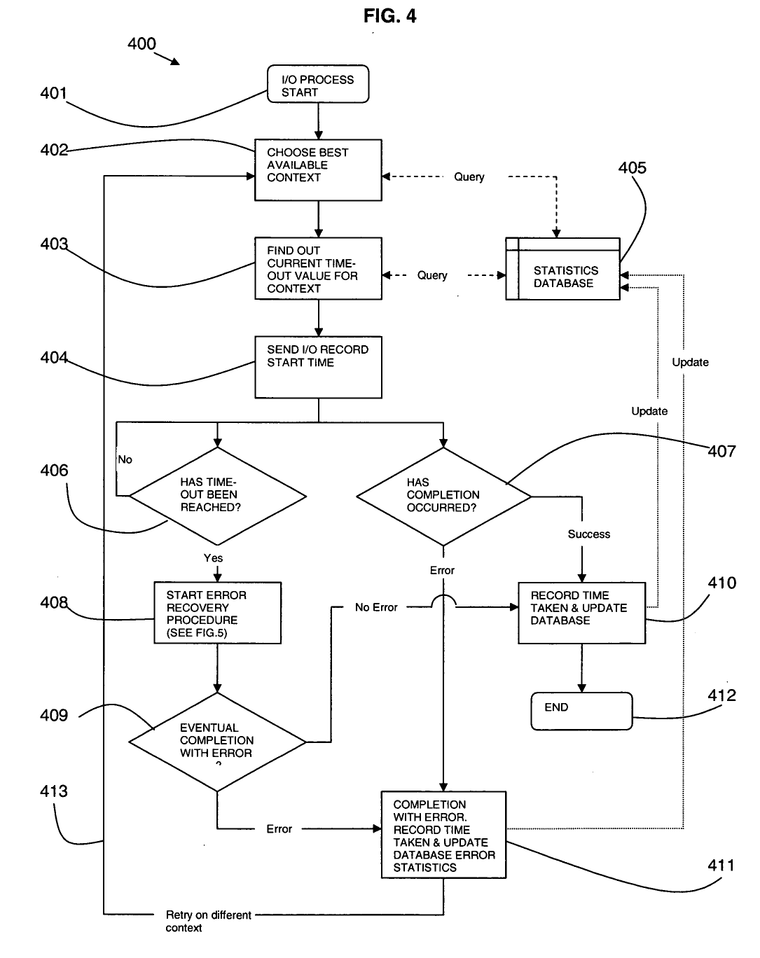

FIG. 4 shows a flow diagram 400 of an example I/O procedure with statistics collection. The I/O process starts 401 and the best available context is chosen 402. This may require a query operation to a statistics database 405 which maintains object representations of the contexts. The term “context” refers to the route between an initiator device and the target devices.

The next step in the process is to find out the current time-out value for the context. Again a query operation is carried out to the statistics database 405.

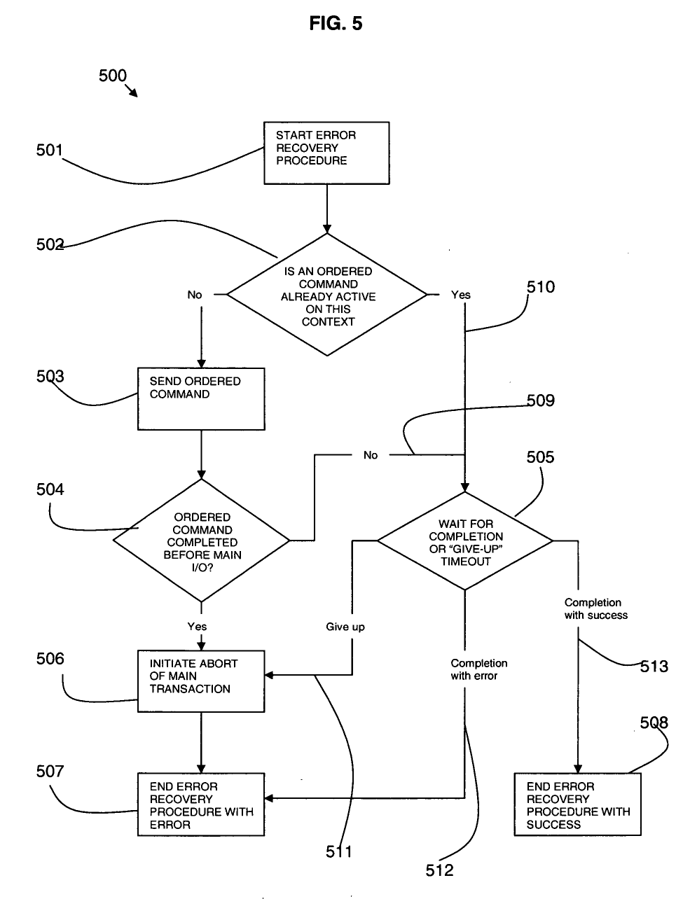

The I/O recorded start time is monitored 404. It is then determined 406 if the time-out for the context has been reached or if completion has occurred. If the time-out has been reached, an error recovery procedure is started (for example as shown in FIG. 5 described below). It is determined if there is eventual completion with error 409.

If there is an error, the completion with error occurs 411 and the time taken is recorded and the statistics database 405 is updated. The process loops 413 to choose a different context 402 and the process is retried on a different context.

If there is no error, the time taken is recorded 410 and the statistics database 405 is updated. This ends 412 the process.

If successful completion occurred 407 without time-out, the operation was successful and the time taken is recorded 410 and the statistics database 405 is updated. This ends 412 the process. If unsuccessful completion occurred 407 without time-out, there was an error and completion with error occurs 411. The time taken is recorded and the statistics database 405 is updated. The process loops 413 to choose a different context 402 and the process is retried on a different context.

FIG. 5 shows an example error recovery procedure 500 in a SCSI interface with ordered commands which may be applied at step 408 of FIG. 4.

The error recovery procedure is started 501 and it is determined 502 if an ordered command is already active on the context.

If there is no ordered command active, an ordered command is sent 503. It is determined if the ordered command completed before the main I/O. If so, abort of the main transaction is initiated 506 and the error recovery procedure is ended with an error 507.

If the ordered command did not complete before the main I/O 509, or an ordered command was already active on the context 510, wait 505 for completion or “give-up” time-out.

If “give-up” time-out 511 is reached, abort of the main transaction is initiated 506 and the error recovery procedure is ended with an error 507. If completion occurs with error 512, the error recovery procedure is ended with an error 507. If completion occurs with success 513, the error recovery procedure is ended with success 508.

### EXAMPLE 1

A given connection over the fabric to a target storage device is generally reliable (perhaps 1 lost frame in 10 million) and the target device is very reliable processing transactions in a very short time (perhaps less than 10 ms for a data transfer round trip).

For this system waiting an unreasonable amount of time, for example, 30 seconds before taking action to recover the error is not necessary. Using the gathered statistics for the target connection, it would be possible to detect the “out of character” behavior much earlier, for example, in 2 seconds as clearly this stands out as being very much longer than normal.

Also, if a subsequent retry of the same transaction takes a long time, the initiator can be much more suspicious of the target storage device and NOT the transport system. The initiator can then take actions that may help recover the storage device itself to normal conditions. The storage controller may be doing error recovery procedures like recovery of a data sector or failure of a component in a RAID array and this may be the cause of the delay. If this is the case, the initiator should wait longer as the condition may pass and normal high speed service resumed. The key point is that a fabric problem has most likely been discounted already after only a short period.

### EXAMPLE 2

A given connection over the fabric to a target storage device is unreliable, for example, 1 lost frame in a few thousand, and the target storage device is generally slow to response to transactions, for example, with a response average of more than 20 seconds, and may even loose transactions by not responding.

Here a very short time-out of even 30 seconds would be unrealistic as a “normal” transaction would cause the time-out error recovery to be required when a longer wait would have been the right thing to do. The described method and system cannot help much with transport errors specifically in this case but will prevent unnecessary error recovery when the target generally takes longer.

Some hosts and storage controller systems use SCSI ordered commands to “flush out” transactions that appear to be taking too long. The time when an ordered command might be sent could be calculated from these statistics. For example, an ordered command could be sent when the current average has been exceeded. If the ordered command completes before the original transaction then the original transaction is not being processed by the target so must be aborted and retried.

The described method and system means that the ordered processing may not be required as it cannot be relied upon as many storage controllers do not implement ordered transaction processing correctly. Of course, the ordered transaction can be lost by the SAN just as easily as any other transaction.

The key point of the described method and system is to allow a timely response to the host attached to the host or storage virtualization controller that is directly related to the speed and reliability of the storage device in which the data is located. For systems that generally perform very well, errors can be recovered without unnecessary delays, while for systems that perform generally very poorly error recovery is kept to a minimum.

Using a relatively small sampling time since the behavior in the last few minutes is all that is of interest, for example, 100 times the peak time for a given target device, the system would be adaptive to normal changes in performance such as high loading and periods of high errors and stresses throughout the day. For instance, many storage controllers have periodic maintenance tasks like data scrubbing and parity validation and during these times the “expectations” of the storage can be dynamically adjusted. Copy services and other normal operations can also impact performance. This would be catered for and can be recorded and reacted to.

The statistics can be recorded and communicated to the user/administrator of the system, and adjustments made to improve or replace problematic components.

Being able to minimize the impact of lost frames in SAN environments is of particular interest to some users who require guaranteed response times. Banking is one industry that sometimes has this requirement, for example, data or error in 4-5 seconds. Clearly a fixed time-out that fits all types of storage controller would not allow this requirement to be met.

Policy based storage management can make use of these statistics to pool storage and parts of the SAN that perform to various levels. These characteristics could be used to stop pollution of a high response quality guaranteed pool of storage with poorly performing storage and/or SAN. According to a first aspect of the present invention there is provided a method for error strategy in a storage system comprising: recording timing statistics for transactions between an initiator and a target storage device; analyzing the recorded timing statistics for a target storage device; and applying the statistical analysis for a target storage device to error recovery procedures for the target storage device.

The initiator and the storage devices are preferably connected via a network and the method includes recording timing statistics for transactions between an initiator and a target storage device using a particular network route.

The timing statistics may include one or more of: a transaction response time, a transaction latency time, a read response time, a write response time, a second attempt transaction response time.

The statistical analysis may include one or more of: averaging the recorded statistics, determining peaks in the recorded statistics, determining the number of errors encountered. The statistical analysis may be carried out for a sample time period preceding a current transaction. The sample time period may be a predetermined number of transactions to a target storage device.

Applying the statistical analysis to error recovery procedures may include dynamically varying an error time-out for a target storage device. Applying the statistical analysis to error recovery procedures may also includes dynamically varying the time before a command is sent to flush out a transaction. Application of the statistical analysis may also determining any timing irregularities of a target storage device when compared to normal timing behavior of the target storage device.

The method may include selecting retry routes between an initiator and a target storage device by applying the recorded timing statistics using a particular route. A different route may be used in a retry attempt of a transaction.

The recorded timing statistics may be maintained for each target storage device and each route to a target storage device available to the initiator. In one embodiment, the method may include managing storage by pooling target storage devices and routes of similar speed and/or reliability.

According to a second aspect of the present invention there is provided a system comprising an initiator and a plurality of storage devices connected by a network, the initiator including: means for recording timing statistics for transactions between the initiator and a target storage device; means for analyzing the recorded timing statistics for a target storage device; and means for applying the statistical analysis for a target storage device to error recovery procedures for the target storage device.

The means for recording timing statistics may include recording timing statistics for routes across the network to a storage device. For example, the network may be one or more storage area networks (SANs). The initiator may be a host computer or a storage virtualization controller.

A target storage device may be a logical unit identified by a logical unit number or a target storage device identified by a unique identifier.

The means for applying the statistical analysis to error recovery procedures may include means for dynamically varying an error time-out for a target storage device. The means for applying the statistical analysis to error recovery procedures may also include means for dynamically varying the time before a command is sent to flush out a transaction. The means for applying the statistical analysis to error recovery procedures may also include means for determining any timing irregularities of a target storage device.

The means for applying the statistical analysis to error recovery procedures may include means for selecting retry routes between an initiator and a target storage device by applying the recorded timing statistics using a particular route.

The means for recording timing statistics may include recorded statistics for each target storage device and each route to a target storage device available to the initiator.

Means for managing storage may be provided by pooling target storage devices and routes of similar speed and/or reliability.

According to a third aspect of the present invention there is provided a computer program product stored on a computer readable storage medium, comprising computer readable program code means for performing the steps of: recording timing statistics for transactions between an initiator and a target storage device; analyzing the recorded timing statistics for a target storage device; and applying the statistical analysis for a target storage device to error recovery procedures for the target storage device.

By gathering statistics such as latency time, average and peak response time, number of errors encountered etc. of a given target storage device and its connections/routes across the fabric it is possible to adjust the time-outs applied to a system. It is also possible to avoid the use of slow or errant connections, and to be able to detect “out of character” behavior and trigger error recovery procedures when they are appropriate. This allows for timely detection of problems when the SAN and the target are fast and reliable or slow and unreliable.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

What is claimed is:

1. A computer program product comprising a computer readable medium including a computer readable program, where the computer readable program when executed on a computer causes the computer to:
record timing statistics for transactions between an initiator and a target storage device;
analyze the recorded timing statistics for the target storage device; and
apply a statistical analysis for the target storage device to at least one error recovery procedure for the target storage device.

2. A computer program product as in claim 1, where the initiator and the target storage device are coupled together via a network, and where the timing statistics for transactions between the initiator and the target storage device are recorded using a particular network route.

3. A computer program product as in claim 1, where the timing statistics include at least one of: a transaction response time, a transaction latency time, a read response time, a write response time, and a second attempt transaction response time.

4. A computer program product as in claim 1, where the statistical analysis includes at least one of: averaging the recorded timing statistics, determining peaks in the recorded timing statistics, and determining a number of errors encountered.

5. A computer program product as in claim 4, where the statistical analysis is carried out for a sample time period that precedes a current transaction.

6. A computer program product as in claim 5, where the sample time period comprises a predetermined number of transactions to the target storage device.

7. A computer program product as in claim 1, where applying the statistical analysis to the at least one error recovery procedure includes dynamically varying an error time-out for the target storage device.

8. A computer program product as in claim 1, where applying the statistical analysis to the at least one error recovery procedure includes dynamically varying an amount of time before a command is sent to flush out a transaction.

9. A computer program product as in claim 1, where applying the statistical analysis to the at least one error recovery procedure includes determining a presence of a timing irregularity of the target storage device.

10. A computer program product as in claim 2, further comprising selecting at least one retry network route between the initiator and the target storage device by applying the recorded timing statistics using the particular network route.

11. A computer program product as in claim 10, wherein applying the statistical analysis to the at least one error recovery procedure includes using a different network route in a retry attempt of a transaction.

12. A computer program product as in claim 1, where the recorded timing statistics are maintained for each target storage device available to the initiator, and for each route to each target storage device available to the initiator.

13. A computer program product as in claim 12, further comprising managing storage by pooling target storage devices and routes having at least one of similar speed and reliability.

14. An initiator device for coupling to a plurality of storage devices through a network, the initiator device comprising:
a recorder to record timing statistics for transactions between the initiator and a target storage device;
an analyzer to analyze the recorded timing statistics for the target storage device; and
a unit to apply a statistical analysis for the target storage device to at least one error recovery procedure for the target storage device.

15. An initiator device as in claim 14, where the recorder records timing statistics for routes across the network to the target storage device.

16. An initiator device as in claim 14, where the network comprises at least one storage area network (SAN).

17. An initiator device as in claim 14, embodied in one of a host computer and a storage virtualization controller.

18. A computer, comprising a data processor coupled to a memory and an input/output interface for coupling to a plurality of data storage devices through a network, the data processor operating in accordance with computer program instructions stored in the memory to record information, during at least one predetermined time interval, for transactions conducted through the interface via a selected connection through the network with at least one data storage device; to statistically analyze the recorded information; and to apply a result of the statistical analysis to at least one data storage device error recovery procedure.

19. A computer as in claim 18, where the recorded information is collected by use of a Send Transaction by recording a time at which the Send Transaction is sent to a target data storage device and a time at which the transaction is completed, further comprising a timer running during the use of the Send Transaction to determine a time-out value for a next transaction (Next timeout).

20. A computer as in claim 18, comprising means for performing a statistical analysis based on at least one of: averaging the recorded timing statistics, determining peaks in the recorded timing statistics, and determining a number of errors encountered.
